(19) United States
(12) Patent Application Publication
(10) Pub. No.: US 2013/0009610 A1
(43) Pub. Date: Jan. 10, 2013

(54) CONTROL SYSTEM FOR DOUBLY-FED INDUCTION MACHINE

(75) Inventors: Jouko Niiranen, Helsinki (FI); Slavomir Seman, Nurnberg (DE); Reijo Virtanen, Vantaa (FI)

(73) Assignee: ABB OY, Helsinki (FI)

(21) Appl. No.: 13/543,331

(22) Filed: Jul. 6, 2012

(30) Foreign Application Priority Data
Jul. 8, 2011 (EP) 11173259.0

(51) Int. Cl. H02P 9/42

(52) U.S. Cl. 322/19

(57) ABSTRACT

A method and arrangement for controlling a doubly-fed induction machine by a frequency converter including a rotor side converter (INU) connected to a rotor circuit of a doubly-fed induction machine (DFIG) and having a control system with rotor flux as a feedback variable, a grid side converter (ISU) connected to an AC power network, and a direct voltage intermediate circuit (DC) connected between the rotor side converter (INU) and the grid side converter (ISU). The method includes forming a rotor flux reference (ψ_{r,ref}), forming a damping signal (ψ_{ref,D}), summing the damping signal and the rotor flux reference for obtaining a modified rotor flux reference (ψ_{ref}), and feeding the modified rotor flux reference to a controller of the rotor side converter (INU) for damping sub-synchronous resonances.

### RELATED APPLICATION(S)

This application claims priority under 35 U.S.C. §119 to European Patent Application No. 11173259.0 filed in Europe on Jul. 8, 2011, the entire content of which is hereby incorporated by reference in its entirety.

### FIELD

The present disclosure relates to doubly-fed machines, for example, to damping of sub-harmonic oscillations of an AC power network by control of doubly-fed machines.

### BACKGROUND INFORMATION

Doubly-fed induction machines can be used in various generator and motor drives. One such electric machine drive including converters can be a doubly-fed slip-ring generator configuration whose rotor circuit includes two converters having a direct voltage intermediate circuit therebetween. One converter can be situated electrically between the direct voltage intermediate circuit and a rotor while the other converter can be situated electrically between the direct voltage intermediate circuit and an electrical network to be supplied.

Such doubly-fed slip-ring generators can be used, for example, in wind turbines. These wind turbines can be located in places where the connection to an electrical network requires a long transmission line. The long line can have a considerable inductance that can limit transmission of the generated power. It is known to alleviate this issue by using capacitance connected in series with the transmission line. This series compensation of the inductance can have the drawback that the capacitor with the inductances of the line and the supplying network form a resonance circuit that has a resonance frequency lower than the nominal frequency (50 or 60 Hz) of the grid.

Excitation of this sub-synchronous resonance can cause a rapid variation of the voltage magnitude and phase, which can cause mechanical and electrical stress to the devices connected to the network, sometimes leading to permanent damage.

Excitation of the sub-synchronous resonance by doubly-fed generators is described, for example, in Jindal, A., Irwin, G. and Woodford, D.: Sub-Synchronous Interactions with Wind Farms Connected Near Series Compensated AC Lines. Proceedings of 9th International Workshop on Large-Scale Integration of Wind Power into Power Systems as well as on Transmission Networks for Offshore Wind Power Plants, Oct. 18-19, 2010, Québec City, Canada.

However, no clear means for damping the resonance is given in the paper.

In Hughes, M., Anaya-Lara, O., Jenkins, N. and Strbac, G.: A Power System Stabilizer for DFIG-Based Wind Generation. IEEE Transactions on Power Systems, Vol. 21, No. 2, May 2006, pp. 763-772, it is proposed to measure the active power in the stator and feed the signal after high-pass filtering to the phase angle reference of the rotor converter. An issue with this approach is that when the generator speed is close to synchronous speed, the rotor voltage can be very low and thus a change in its phase angle has little damping effect. For this reason, it is difficult or impossible to operate the converter at this speed range if resonance exists in the network.

### SUMMARY

A method is disclosed of controlling a doubly-fed induction machine by a frequency converter including a rotor side converter (INU) connected to a rotor circuit of the doubly-fed induction machine (DFIG) and having a control system with rotor flux as a feedback variable, a grid side converter (ISU) connected to an AC power network, and a direct voltage intermediate circuit (DC) connected between the rotor side converter (INU) and the grid side converter (ISU), forming a rotor flux reference (ψ_{r,ref}), forming a damping signal (ψ_{ref,D}), summing the damping signal and the rotor flux reference for obtaining a modified rotor flux reference (ψ_{ref}), and feeding the modified rotor flux reference to a controller of the rotor side converter (INU) for damping sub-synchronous resonances.

An arrangement for controlling a doubly-fed induction machine with a frequency converter, including a rotor side converter (INU) connected to a rotor circuit of the doubly-fed induction machine (DFIG) and having a control system with rotor flux as a feedback variable, a grid side converter (ISU) connected to an AC power network, and a direct voltage intermediate circuit (DC) connected between the rotor side converter (INU) and the grid side converter (ISU), means for forming a rotor flux reference (ψ_{r,ref}), wherein the arrangement comprises means for forming a damping signal (ψ_{ref,D}), means for summing the damping signal and the rotor flux reference for obtaining a modified rotor flux reference (ψ_{ref}), and means for feeding the modified rotor flux reference to a controller of the rotor side converter (INU) for damping sub-synchronous resonances.

### BRIEF DESCRIPTION OF THE DRAWINGS

In the following, the disclosure will be described in greater detail by means of exemplary embodiments with reference to the accompanying drawings, in which

FIG. 1 shows a simulation of network voltage oscillation with a known control system when sub-synchronous resonance is excited;

FIG. 2 shows a control system including damping control according to an exemplary embodiment of the disclosure;

FIG. 3 shows a block diagram of formation of a damping signal;

FIG. 4 shows the same simulation as in FIG. 1 with the damping control according to an exemplary embodiment of the disclosure; and

FIG. 5 shows performance of the damping control according to an exemplary embodiment of the disclosure when a fault occurs in the grid, causing a voltage dip.

### DETAILED DESCRIPTION

Exemplary embodiments of the present disclosure provide a method and an arrangement for implementing the method so as to solve the above issues in connection with doubly-fed induction generators.

Exemplary embodiments of the disclosure are based on the idea of modifying a rotor flux reference in the control system controlling the rotor flux. The modified rotor flux reference can be obtained by summing a damping signal to a signal that can be used as a rotor flux reference. The modified rotor flux signal is then used in the control as the reference signal.

The damping signal can be formed on the basis of an estimated machine torque or another signal having similar characteristics.

An advantage of the method and arrangement is that it can damp effectively sub-synchronous oscillations so that the network can be used securely and the production of power can be stable.

A further advantage is that it can be used throughout the whole speed range for stabilizing the operation. The exemplary embodiments of the disclosure require minimal changes to the current control structure, thus the disclosure is easily implemented.

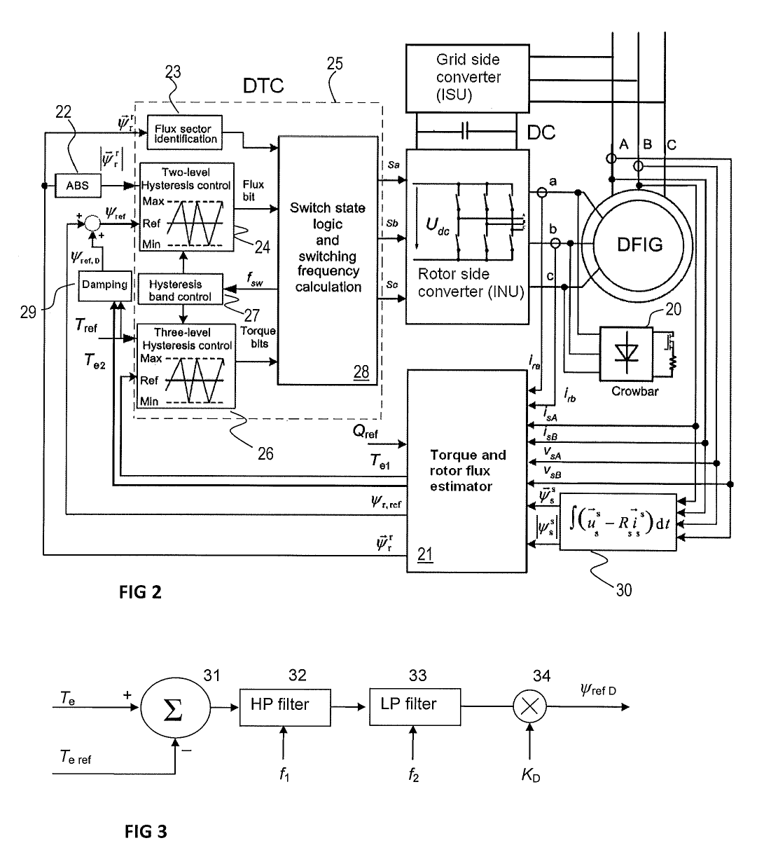

FIG. 2 shows an example of a control system together with a frequency converter for controlling a doubly-fed induction generator (DFIG) according to an exemplary embodiment of the disclosure. The control system in FIG. 2 is based on direct torque control. The direct torque control has been found to be prone to excite sub-synchronous resonances already at moderate compensation levels of a transmission line inductance.

An example of a direct torque controlled system is disclosed, for example, in U.S. Pat. No 6,741,059. In direct torque controlled systems, such as that in the above-mentioned U.S. patent, the machine torque and rotor flux are controlled variables. The actual values of torque and rotor flux vector are estimated from a measured stator current vector, a measured rotor current vector, and a stator flux vector. The stator flux vector is estimated by integrating a stator voltage vector.

In FIG. 2, a stator of the doubly-fed induction generator is connected to the supplied network having phases A, B, C. Further, a grid side converter (ISU) is connected to the network and to a DC intermediate circuit (DC). A rotor side converter (INU) is connected to the rotor of the DFIG having phases a, b, c. FIG. 2 also shows a crowbar circuit 20 connected to the rotor circuit.

Stator currents isA, isB and voltages vsA, vsB are measured, and these values are fed to a torque and flux estimator block 21. The torque and flux estimator block 21 receives a further calculated stator flux vector \vec{ψ}^{S}_{S}, and the magnitude of the stator flux \vec{ψ}^{S}_{S} from a stator flux calculation block 30. The stator flux is calculated from measured stator voltages, stator currents and from the stator resistance. The torque and flux estimator block 21 also receives a reactive power reference Qref.

The torque and rotor flux estimator block 21 estimates the torque of a machine Te1, Te2 and the rotor flux \vec{ψ}^{r}ᵣ. The estimated torque Te1 is fed to a three-level hysteresis control block 26 together with a torque reference Tref. The estimated rotor flux vector is fed to a flux sector identification block 23 and to an ABS block 22 which calculates the length of the rotor flux vector and feeds it further to a two-level hysteresis control block 24 inside a DTC control block 25. The two-level hysteresis control block 24 also receives a reference for rotor flux ψ_{ref}.

In known DTC control, the flux reference ψ_{ref} can be obtained directly from the torque and rotor flux estimator block 21. However, in exemplary embodiments of the present disclosure, the flux reference supplied to a DTC-modulator is a modified flux reference which is obtained by summing the reference ψ_{r,ref} from the torque and rotor flux estimator 21 with a damping signal from a damping block 29. According to the exemplary embodiment of FIG. 2, the damping signal can be obtained using the torque reference Tref and the torque estimate Te2. In the example of FIG. 2, the torque estimate for damping is calculated in the estimator block 21.

The two-level hysteresis control block 24 and the three-level hysteresis control block 26 also receive input from a hysteresis band control block 27. The hysteresis band control block 27 controls the width of the hysteresis bands and thereby affects the switching frequency. Therefore, the hysteresis band control block receives input from a switch state logic and switching frequency calculation block 28 which controls the switching frequency fsw. The hysteresis control blocks output a flux bit and torque bits for the switch state logic block 28 which also receives information on the sector of the rotor flux from the flux sector identification block 23.

The switch state logic and switching frequency calculation block 28 outputs switching instructions sa, sb, sc to the rotor side converter.

As mentioned above, the modified rotor flux reference is used in the modulator. FIG. 3 shows an example of calculation of this modified signal. The torque reference Te ref is subtracted 31 from the torque estimate Te. The result of this subtraction is both high-pass filtered 32 and low-pass filtered 33 for removing possible offset and high frequency noise from the difference signal. The filtered signal is further multiplied with an amplification factor KD which can be used for defining a correct magnitude for the damping signal that is added to the flux reference as shown in FIG. 2. It is clear that the low-pass filter and the high-pass filter can be combined to form a band-pass filter.

If necessary, a suitable phase shift adjustment may also be used in addition to amplification adjustment to further enhance the damping. The phase shift adjustment can be incorporated into the filtering section.

Once the modified rotor flux reference is used instead of one obtained directly from the torque and rotor flux estimator, the oscillations are greatly reduced. The modified rotor flux reference is proportional to the torque oscillations which are due to the voltage oscillations in the grid.

Instead of using torque for generating the damping signal as shown in FIGS. 2 and 3, other signals may also be used. Signals containing oscillation and thereby being usable in damping oscillations include estimated stator power and measured DC intermediate link voltage, i.e. DC bus voltage. As the oscillations are reflected to these signals, they are also usable in compensation. If, for example, a measured DC link voltage is used, it can be subtracted from the DC voltage reference and the procedure would be the same as that in FIG. 3 in connection with torques.

The disclosure is described above in connection with FIG. 2 with a control system based on direct torque control (DTC). However, the disclosure is not limited to DTC. Other control schemes to which the method is applicable include vector control, in which the flux is estimated using a motor model and the flux is used as a feedback variable. The flux reference is modified in a manner similar to that used in connection with FIG. 2 in different control system.

The estimated torque Te in FIG. 2 may be estimated in several ways, some of which being listed here below.

$${T}_{est} = \frac{1}{siglm} Im \{ {Ψ}_{stator}^{*} * {Ψ}_{rotor} \}$$

$${T}_{est} = {L}_{m} Im \{ {Ψ}_{stator}^{*} * {i}_{s} \}$$

$${T}_{est} = {L}_{m} Im \{ {i}_{r}^{*} * {i}_{s} \}$$

$${T}_{est} = - Im \{ {Ψ}_{rotor}^{*} * {i}_{r} \}$$

The torque can thus be estimated using stator and rotor fluxes Ψₛₜₐₜₒᵣ, Ψᵣₒₜₒᵣ, stator and rotor currents iₛ, iᵣ, and magnetizing inductance L^{m} in different ways.

The estimated torque used by the damping block 29 and the estimated torque fed to the torque controller 26 can be calculated differently from each other. The torque used for torque control can be calculated using only the positive sequence component of the flux and/or current. In FIG. 2 it is shown that the same torque signal is fed to both blocks 26 and 29.

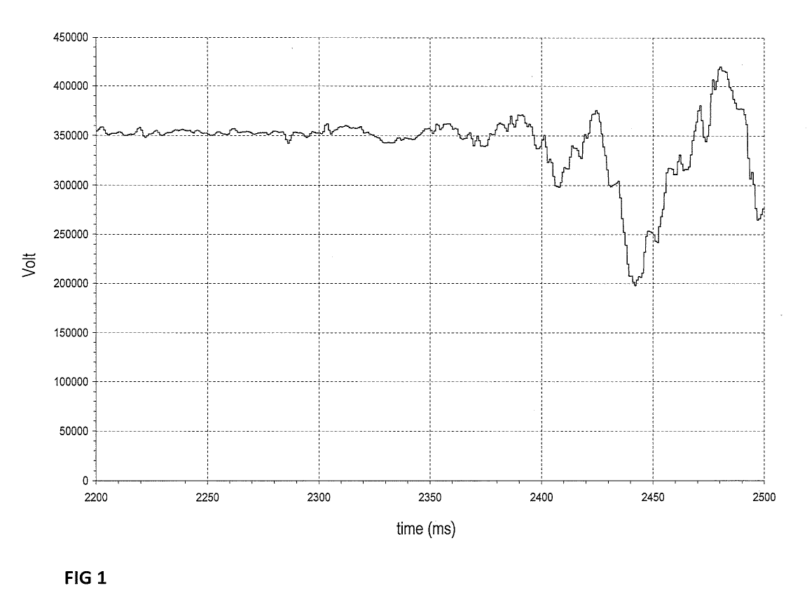

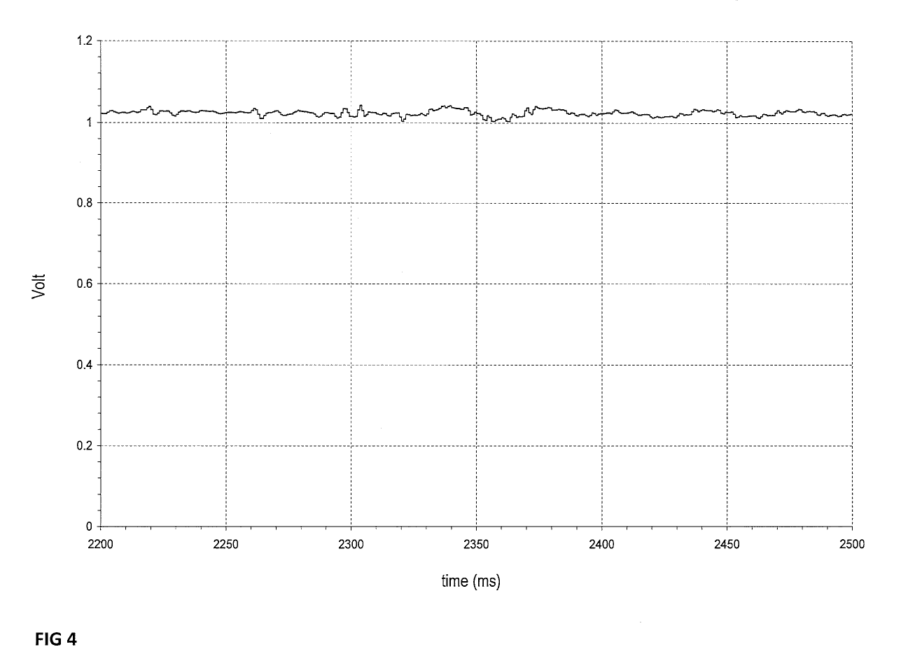

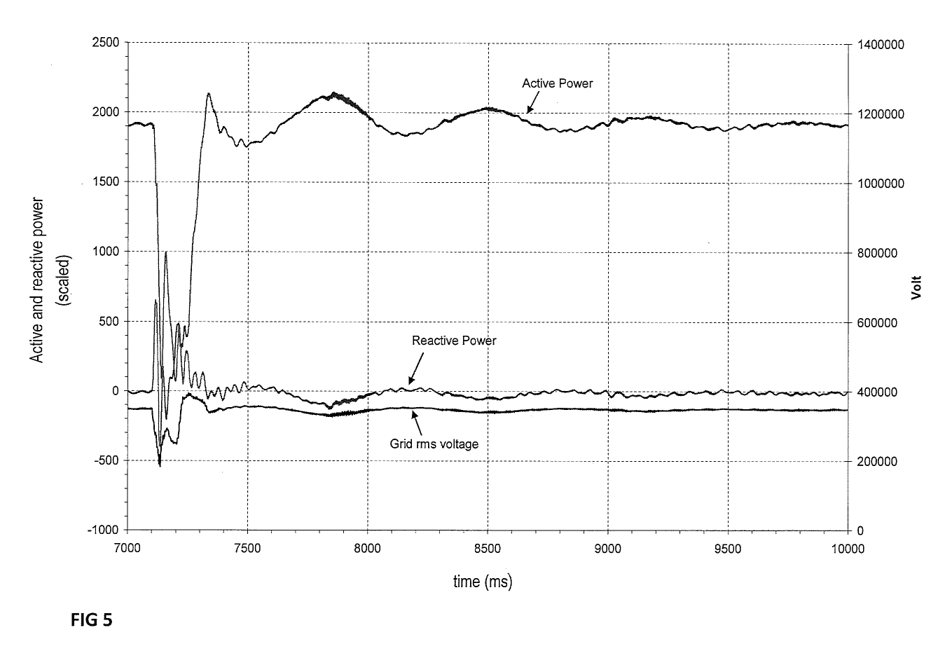

Using the damping according to the exemplary embodiments of the disclosure can ensure a stable operation of the AC power network even during and after faults as can be seen in FIGS. 4 and 5. FIG. 4 shows a simulated voltage waveform. In FIG. 4, the same simulation is carried out as in connection with FIG. 1. The stable waveform of FIG. 4 is enabled by the method of exemplary embodiments of the disclosure used in the simulation. It can be seen that the voltage waveform contains no oscillation.

In FIG. 5, a situation is simulated in which the voltage of the network collapses. The simulated waveforms show that once the voltage of the network is recovered, the active power stabilizes quickly. During the fault, the system feeds reactive power to the network for supporting the voltage.

Exemplary embodiments of the present disclosure have been described with respect to the operative features the structural components perform. The exemplary embodiments of the present disclosure can also be implemented by at least one processor (e.g., general purpose or application specific) of a computer processing device which is configured to execute a computer program tangibly recorded on a non-transitory computer-readable recording medium, such as a hard disk drive flash memory, optical memory or any other type of non-volatile memory. Upon executing the program, the at least one processor is configured to perform the operative functions of the above-described exemplary embodiments.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method of controlling a doubly-fed induction machine by a frequency converter including a rotor side converter (INU) connected to a rotor circuit of the doubly-fed induction machine (DFIG) and having a control system with rotor flux as a feedback variable, a grid side converter (ISU) connected to an AC power network, and a direct voltage intermediate circuit (DC) connected between the rotor side converter (INU) and the grid side converter (ISU), the method comprising:
forming a rotor flux reference (ψ_{r,ref});
forming a damping signal (ψ_{ref,D});
summing the damping signal and the rotor flux reference for obtaining a modified rotor flux reference (ψ_{ref}); and
feeding the modified rotor flux reference to a controller of the rotor side converter (INU) for damping sub-synchronous resonances.

2. The method according to claim 1, comprising:
basing the control system on direct torque control.

3. The method according to claim 1, comprising:
basing the control system on vector control.

4. The method according to claim 1, wherein the damping signal is proportional to oscillation in an estimated torque.

5. The method according to claim 1, wherein the damping signal is proportional to oscillation in estimated stator power.

6. The method according to claim 1, wherein the damping signal is proportional to oscillation in a measured intermediate DC circuit voltage.

7. The method according to claim 1, comprising:
obtaining the damping signal from an oscillating signal by filtering it with low-pass and high-pass filters or a band-pass filter.

8. The method according to claim 1, comprising:
adjusting a damping signal amplitude.

9. The method according to claim 1, comprising:
adjusting a damping signal phase.

10. An arrangement for controlling a doubly-fed induction machine with a frequency converter, including a rotor side converter (INU) connected to a rotor circuit of the doubly-fed induction machine (DFIG) and having a control system with rotor flux as a feedback variable, a grid side converter (ISU) connected to an AC power network, and a direct voltage intermediate circuit (DC) connected between the rotor side converter (INU) and the grid side converter (ISU), the arrangement comprising:
means for forming a rotor flux reference (ψ_{r,ref});
means for forming a damping signal (ψ_{ref,D});
means for summing the damping signal and the rotor flux reference for obtaining a modified rotor flux reference (ψ_{ref}); and
means for feeding the modified rotor flux reference to a controller of the rotor side converter (INU) for damping sub-synchronous resonances.

11. The arrangement according to claim 10, comprising:
a control system based on direct torque control.

12. The arrangement according to claim 10, comprising:
a control system based on vector control.

13. The arrangement according claim 10, wherein the damping signal is proportional to oscillation in an estimated torque.

14. The arrangement according to claim 10, wherein the damping signal is proportional to oscillation in estimated stator power.

15. The arrangement according to claim 10, wherein the damping signal is proportional to oscillation in a measured intermediate DC circuit voltage.

16. The arrangement according claim 11, wherein the damping signal is proportional to oscillation in an estimated torque.

17. The arrangement according claim 12, wherein the damping signal is proportional to oscillation in an estimated torque.

18. The arrangement according to claim 11, wherein the damping signal is proportional to oscillation in estimated stator power.

19. The arrangement according to claim 12, wherein the damping signal is proportional to oscillation in estimated stator power.

20. The arrangement according to claim 11, wherein the damping signal is proportional to oscillation in a measured intermediate DC circuit voltage.
